(19) United States
(12) Patent Application Publication
(10) Pub. No.: US 2025/0284263 A1
(43) Pub. Date: Sep. 11, 2025

(54) CONTROL DEVICE, MACHINE TOOL, AND CONTROL METHOD

(71) Applicant: FANUC CORPORATION, Minamitsuru-gun, Yamanashi (JP)

(72) Inventor: Yuuta IMAMATSU, Minamitsuru-gun, Yamanashi-ken (JP)

(73) Assignee: FANUC CORPORATION, Minamitsuru-gun, Yamanashi (JP)

(21) Appl. No.: 18/862,346

(22) PCT Filed: May 12, 2022
(86) PCT No.: PCT/JP2022/020031

§ 371 Date: Nov. 1, 2024

(51) Int. Cl. G05B 19/18; B23Q 11/10; B23Q 17/00

(52) U.S. Cl. CPC G05B 19/18; B23Q 11/10; B23Q 17/007; G05B 2219/50

(57) ABSTRACT

A control device of a machine tool comprising a table that supports an object to be machined, a main shaft on which a tool is mounted, and a mist collector that collects mist comprises: an acquisition unit that acquires at least one piece of information from among a machining load, a relative movement speed of the main shaft in relation to the table, and a rotational speed of the main shaft; a startup determination unit that determines whether to start the mist collector on the basis of the at least one piece of acquired information; and a collector control unit that automatically controls the mist collector on the basis of the determination details.

### TECHNICAL FIELD

The present invention relates to a control device, a machine tool, and a control method.

### BACKGROUND ART

A mist collector collects mist generated within a machining area of a machine tool (refer also to JP 2012-076006 A). The mist collector collects the mist within the machining area, and prevents the mist from leaking out to the exterior of the machining area. The mist is a coolant of fine or minute particles that are suspended within the air.

### SUMMARY OF THE INVENTION

The mist collector vibrates when operated. Depending on the content of machining performed by the machine tool, vibration of the mist collector may have a significant adverse effect on the machine accuracy of the machine tool.

An object of the present invention is to solve the aforementioned problem.

A first aspect of the present invention is a control device for a machine tool including a table supporting a workpiece to be machined by a tool in a machining area, a spindle to which the tool is mounted and which rotates and moves relative to the table, and a mist collector configured to collect mist in the machining area, the control device including an acquisition unit configured to acquire at least one type of information from among a machining load applied to the tool by performing machining on the workpiece, a relative movement speed of the spindle with respect to the table, and a rotational speed of the spindle, a start determination unit configured to determine whether or not to start the mist collector based on the at least one type of information acquired by the acquisition unit, and a collector control unit configured to automatically control the mist collector based on a determination content of the start determination unit.

A second aspect of the present invention is a machine tool including the control device according to the first aspect.

A third aspect of the present invention is a control method for a machine tool including a table supporting a workpiece to be machined by a tool in a machining area, a spindle to which the tool is mounted and which rotates and moves relative to the table, and a mist collector configured to collect mist in the machining area, the control method including an acquisition step in which a computer acquires at least one type of information from among a machining load applied to the tool by performing machining on the workpiece, a relative movement speed of the spindle with respect to the table, and a rotational speed of the spindle, a start determination step in which the computer determines whether or not to start the mist collector based on the at least one type of information acquired in the acquisition step, and a collector control step in which the computer controls the mist collector based on a determination content in the start determination step.

According to the present invention, since the mist collector is automatically controlled in accordance with the content of processing, vibration of the mist collector is prevented from having a large adverse effect on the machine accuracy.

### BRIEF DESCRIPTION OF DRAWINGS

FIG. 1 is a schematic diagram of a machine tool according to an embodiment;

FIG. 2 is a block diagram of a control device;

FIG. 3 is a flowchart illustrating a control method according to an embodiment;

FIG. 4 is a schematic diagram of a machine tool according to an exemplary modification 1;

FIG. 5 is a block diagram of a control device according to an exemplary modification 2; and

FIG. 6 is a block diagram of a control device according to an exemplary modification 3.

### DETAILED DESCRIPTION OF THE INVENTION

### Embodiment

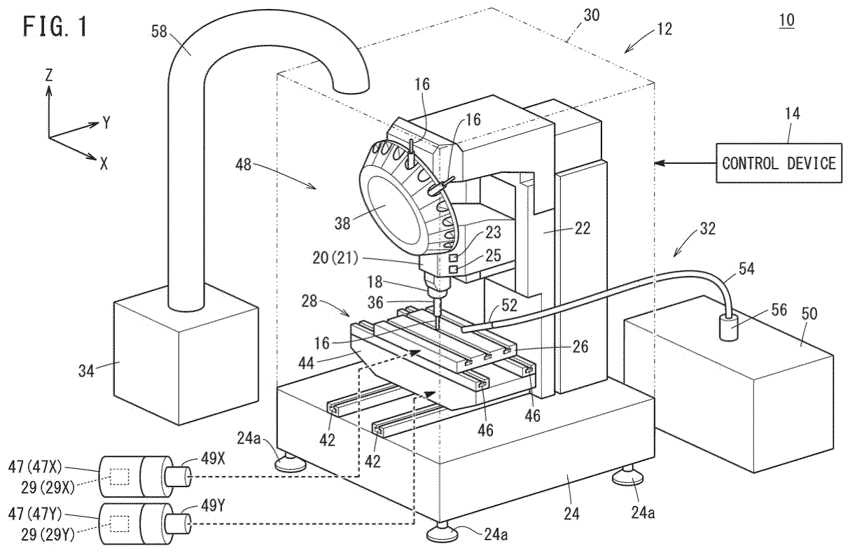

FIG. 1 is a schematic diagram of a machine tool 10 according to an embodiment.

The X direction and the Y direction shown in FIG. 1 are directions that are parallel to a horizontal plane. The X direction and the Y direction are mutually orthogonal with each other. The Z direction shown in FIG. 1 is a direction that is parallel to the direction of gravity. Accordingly, the Z direction is perpendicular to the X direction and the Y direction. However, the Z direction shown in FIG. 1 indicates a direction that is opposite to the direction of gravity.

The machine tool 10 includes a machining device 12 and a control device 14.

The machining device 12 is a machine that carries out machining on a workpiece using a tool 16. The machining device 12 is equipped with a spindle 18, a spindle head 20, a column 22, a pedestal 24, a table 26, a table drive unit 28, a cover 30, a coolant supply device 32, and a mist collector 34.

A tool holder 36 is attached to the spindle 18 (refer to FIG. 1). The tool holder 36 is capable of being attached and detached to and from the spindle 18. The tool holder 36 retains the tool 16. The tool 16, for example, is a spring-necked turning tool, a drill, an end mill, a milling cutter, or the like.

The machining device 12 is further equipped with a tool magazine 38. The tool magazine 38 detachably retains a plurality of the tools 16. One of the plurality of the tools 16 that are retained in the tool magazine 38 is changeably attached to the tool holder 36.

The spindle head 20 supports the spindle 18. The spindle head 20 is provided with a spindle motor 21 for rotating the spindle 18. The spindle motor 21 is, for example, a spindle motor. The spindle motor 21 includes a shaft (not shown). The tool 16 mounted on the spindle 18 via the tool holder 36 rotates in accordance with the rotation of the shaft of the spindle motor 21.

The spindle motor 21 includes a torque sensor 23 and an encoder 25. The torque sensor 23 outputs a detection signal corresponding to the output torque of the spindle motor 21. The encoder 25 is a rotary encoder. The encoder 25 outputs a detection signal corresponding to the rotational position of the shaft of the spindle motor 21. The detection signal of the torque sensor 23 and the detection signal of the encoder 25 are input to the control device 14. The control device 14 will be described in more detail later.

The column 22 supports the spindle head 20. Further, the column 22 includes a motor that causes the spindle head 20 to be moved in the Z direction. The column 22 is supported on the pedestal 24.

The pedestal 24 is installed on an installation surface. The installation surface, for example, is a floor of a factory. The installation surface may be a support surface of a platform that is provided on the floor. The installation surface extends, for example, parallel to the horizontal plane. The pedestal 24 may be equipped with a plurality of leg members 24a. Each of the leg members 24a, for example, may be a caster, a jack, or the like.

The table drive unit 28 is supported on the pedestal 24. The table drive unit 28 includes a first slide unit 42, a saddle 44, a second slide unit 46, and a plurality of feed axis motors 47 (47X, 47Y). The plurality of feed axis motors 47 include a Y-axis motor 47Y and an X-axis motor 47X.

The first slide unit 42 is provided on the pedestal 24. The first slide unit 42 includes, for example, guide rails that extend in the Y direction. The first slide unit 42 supports the saddle 44.

The saddle 44 moves in the Y direction in response to the driving of the Y-axis motor 47Y. The Y-axis motor 47Y is controlled by the control device 14. The saddle 44 moves while being guided by the first slide unit 42.

The Y-axis motor 47Y is, for example, a servo motor. The Y-axis motor 47Y includes a shaft 49Y and an encoder 29 (29Y). The shaft 49Y rotates in accordance with a drive current supplied to the Y-axis motor 47Y. The encoder 29Y is a rotary encoder. The encoder 29Y outputs a detection signal corresponding to the rotational position of the shaft 49Y. The detection signal of the encoder 29Y is input to the control device 14.

The second slide unit 46 is provided on the saddle 44. The second slide unit 46 includes, for example, guide rails that extend in the X direction.

The table 26 supports a non-illustrated workpiece downwardly of the spindle 18. The table 26 is supported on the second slide unit 46. The table 26 moves in the X direction in response to the driving of the X-axis motor 47X. The X-axis motor 47X is controlled by the control device 14. The table 26 moves while being guided by the second slide unit 46.

The X-axis motor 47X is, for example, a servo motor. The X-axis motor 47X includes a shaft 49X and an encoder 29 (29X). The shaft 49X rotates in accordance with a drive current supplied to the X-axis motor 47X. The encoder 29X is a rotary encoder. The encoder 29X outputs a detection signal corresponding to the rotational position of the shaft 49X. The detection signal of the encoder 29X is input to the control device 14.

The cover 30 covers the spindle 18, the spindle head 20, the column 22, the pedestal 24, the table 26, and the table drive unit 28. Consequently, the cover 30 forms a machining area 48. A workpiece is machined within the machining area 48.

The cover 30 is further equipped with a non-illustrated door and a non-illustrated window. The operator can carry out an introduction operation of the workpiece into the machining area 48 through the door that is in an opened state. Further, the operator can easily confirm the condition within the machining area 48 via the window.

The coolant supply device 32 is a device that supplies the coolant to the machining area 48. The coolant supply device 32 is equipped with a coolant tank 50, a nozzle 52, a supply pipe 54, and a pump 56.

The coolant tank 50 stores the coolant. The coolant tank 50 is provided externally of the machining area 48.

The nozzle 52 is a discharge unit that discharges the coolant. The nozzle 52 is disposed within the machining area 48. Moreover, the coolant supply device 32 may be equipped with a plurality of the nozzles 52.

The supply pipe 54 is a pipe that connects the coolant tank 50 and the nozzle 52. Moreover, the coolant supply device 32 may be equipped with a plurality of the supply pipes 54. The number of the supply pipes 54 is determined, for example, in accordance with the number of the nozzles 52. The supply pipe 54 passes through the cover 30, and connects the coolant tank 50 and the nozzle 52.

The pump 56 is connected to the supply pipe 54. The pump 56 draws in the coolant within the coolant tank 50, and delivers the coolant to the nozzle 52. Consequently, the coolant is discharged from the nozzle 52 into the machining area 48. Moreover, the pump 56 is controlled by the control device 14.

The coolant that is discharged into the machining area 48 cools the tool 16 and the workpiece. When machining is carried out in the machining area 48, a mist of the coolant is generated. There is a concern that the mist may leak out to the exterior of the machining area 48 via small gaps that occur in the machining device 12.

The mist collector 34 is a device that serves to collect the mist within the machining area 48. The mist collector 34 is provided outside the machining area 48. Further, the mist collector 34 is connected to the cover 30 via a duct 58. The mist collector 34 collects the mist by drawing in air within the machining area 48. In accordance with this feature, the mist is prevented from leaking out to the exterior of the machining area 48.

By the tool 16 cutting the workpiece, fine or minute cutting chips are generated in the form of powdery dust within the machining area 48. There is a concern that the powdery dust, in the same manner as the mist, may leak out to the exterior of the machining area 48 via small gaps that occur in the machining device 12. The mist collector 34, by drawing in air within the machining area 48, may collect not only the mist, but also the powdery dust. In accordance with this feature, the powdery dust is prevented from leaking out to the exterior of the machining area 48.

The mist collector 34 may be connected to the coolant tank 50. Consequently, the mist that is collected by the mist collector 34 can be returned, as the coolant, to the coolant tank 50.

In the case that the mist collector 34 and the coolant tank 50 are connected to each other, it is preferable for the mist collector 34 and the coolant tank 50 to be connected to each other via a non-illustrated filtering device (filter). The filtering device removes impurities in the coolant sent from the mist collector 34 to the coolant tank 50. By connecting the mist collector 34 and the coolant tank 50 via the filtering device, a clean coolant can be returned from the mist collector 34 to the coolant tank 50. Impurities in the coolant, for example, are the cutting chips that have been collected together with the mist.

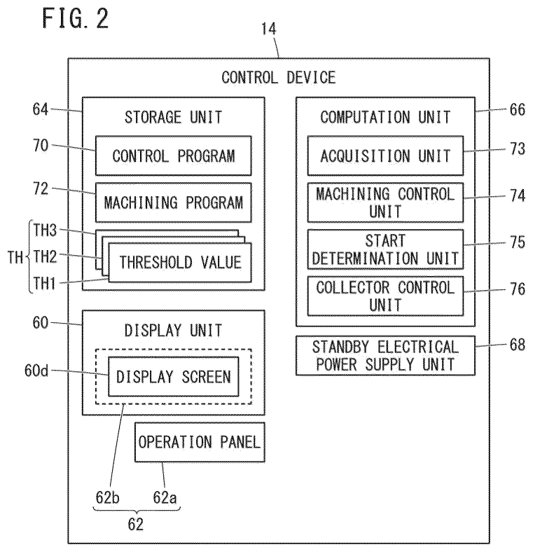

FIG. 2 is a block diagram of the control device 14.

The control device 14 is a computer that controls the machining device 12. The control device 14, for example, is a numerical control device. The control device 14 is equipped with a display unit 60, an operation unit 62, a storage unit 64, a computation unit 66, and a standby electrical power supply unit 68.

The display unit 60 is a display device equipped with a display screen 60d. The display unit 60, for example, is a liquid crystal display device or an OEL (Organic Electro-Luminescence) display device.

The operation unit 62 is an input device that receives instructions from the operator to the control device 14. The operation unit 62 includes, for example, an operation panel 62a, and a touch panel 62b or the like. The touch panel 62b is provided on the display screen 60d. The operation unit 62 (the operation panel 62a) may be equipped with a keyboard, a mouse, or the like.

The storage unit 64 is constituted by a non-illustrated volatile memory, and a non-illustrated nonvolatile memory. As an example of the volatile memory, there may be cited a random access memory (RAM) or the like. As an example of the nonvolatile memory, there may be cited a ROM (Read Only Memory) and a flash memory or the like. Data and the like may be stored, for example, in the volatile memory. A program, a data table, a map and the like may be stored, for example, in the nonvolatile memory. At least a portion of the storage unit 64 may be provided in the aforementioned processor, an integrated circuit, or the like. The storage unit 64 stores a control program 70, a machining program 72, and a plurality of threshold values TH (TH1, TH2, TH3).

The control program 70 is a program for the purpose of causing the control device 14 to execute the control method according to the present embodiment. The control method will be described in more detail later.

The machining program 72 is a program including control commands for the machining device 12. The machining program 72 includes, for example, a plurality of control commands for controlling the plurality of motors (21, 47). Further, the machining program 72 also includes, for example, a plurality of control commands for the purpose of controlling the coolant supply device 32. The machining program 72 is created or edited in advance by the operator.

The plurality of threshold values TH include a threshold value TH1 for a machining load LO, a threshold value TH2 for a relative movement speed VR, and a threshold value TH3 for the rotational speed VS of the spindle 18. The machining load LO is a load applied to the tool 16 for machining the workpiece. The relative movement speed VR is a relative movement speed of the spindle 18 with respect to the table 26. The relative movement speed VR includes a relative movement speed VRX and a relative movement speed VRY. The relative movement speed VRX is the relative movement speed of the spindle 18 in the X direction with respect to the table 26. The relative movement speed VRY is a relative movement speed of the spindle 18 in the Y direction with respect to the table 26.

The threshold value TH1 is, for example, the maximum allowable value of the machining load LO in predetermined machining. The predetermined machining refers to machining in which the vibration of the mist collector 34 greatly affects the machine accuracy. The predetermined machining includes, for example, finishing, precision machining, or the like. The threshold value TH2 is, for example, a maximum allowable value of the relative movement speed VR in the predetermined machining. The storage unit 64 may store the threshold value TH2 for the relative movement speed VRX and the threshold value TH2 for the relative movement speed VRY. In this case, the threshold value TH2 for the relative movement speed VRX and the threshold value TH2 for the relative movement speed VRY may be equal to or different from each other. The threshold value TH3 is, for example, a maximum allowable value of the rotational speed VS of the spindle 18 in the predetermined machining. The specific values of the respective threshold values TH (TH1 to TH3) are determined based on experiments. The specific values of the respective threshold values TH (TH1 to TH3) may be provided to the operator from the manufacturer of the machine tool 10.

The computation unit 66 is constituted by a processor including, for example, a CPU (Central Processing Unit), and a GPU (Graphics Processing Unit) or the like. More specifically, the computation unit 66 can be constituted by a processing circuit (Processing Circuitry).

The computation unit 66 includes an acquisition unit 73, a machining control unit 74, a start determination unit 75, and a collector control unit 76. The acquisition unit 73, the machining control unit 74, the start determination unit 75, and the collector control unit 76 are implemented by the computation unit 66 executing the control program 70. At least a portion of the acquisition unit 73, the machining control unit 74, the start determination unit 75, and the collector control unit 76 may be realized by an integrated circuit such as an ASIC (Application Specific Integrated Circuit) or an FPGA (Field-Programmable Gate Array). At least a portion of the acquisition unit 73, the machining control unit 74, the start determination unit 75, and the collector control unit 76 may be configured by an electronic circuit including a discrete device.

The acquisition unit 73 acquires at least one type of information from among the machining load LO, the relative movement speed VR, and the rotational speed VS. When acquiring the relative movement speed VR, the acquisition unit 73 may acquire both the relative movement speed VRX and the relative movement speed VRY, or may acquire only one of them. When acquiring only one of the relative movement speed VRX and the relative movement speed VRY, the acquisition unit 73 may acquire the one having the larger absolute value.

The machining load LO is calculated based on the torque of the spindle motor 21. The torque of the spindle motor 21 is calculated based on a detection signal output from the torque sensor 23. Therefore, the acquisition unit 73 can acquire the information of the machining load LO based on the detection signal output from the torque sensor 23.

The relative movement speed VRX is calculated based on the rotational speed of the shaft 49X. The rotational speed of the shaft 49X is calculated based on a detection signal output from the encoder 29X. Therefore, the acquisition unit 73 can acquire the information of the relative movement speed VRX based on the detection signal output from the encoder 29X.

The relative movement speed VRY is calculated based on the rotational speed of the shaft 49Y. The rotational speed of the shaft 49Y is calculated based on a detection signal output from the encoder 29Y. Accordingly, the acquisition unit 73 can acquire the information of the relative movement speed VRY based on the detection signal output from the encoder 29Y to the control device 14.

The rotational speed VS is calculated based on the rotational speed of the shaft of the spindle motor 21. The rotational speed of the shaft of the spindle motor 21 is calculated based on a detection signal output from the encoder 25. Therefore, the acquisition unit 73 can acquire the information of the rotational speed VS based on the detection signal output from the encoder 25.

The machining control unit 74, by controlling the machining device 12 based on the machining program 72, carries out machining on the workpiece. For example, the machining control unit 74 controls the spindle motor 21, the plurality of feed axis motors 47, and the like based on the machining program 72. However, within the machining device 12, the mist collector 34 is controlled by the collector control unit 76.

The start determination unit 75 determines whether or not a predetermined start condition is satisfied based on the information (the machining load LO, the relative movement speed VR, and the rotational speed VS) acquired by the acquisition unit 73. The predetermined start condition is satisfied when at least one of the machining load LO, the relative movement speed VR, and the rotational speed VS acquired by the acquisition unit 73 is equal to or greater than the threshold value TH.

The start determination unit 75 determines whether at least one of (1) to (3) described below is satisfied in order to determine whether a predetermined start condition is satisfied: (1) Whether or not the machining load LO is equal to or greater than the threshold value TH1; (2) Whether or not the relative movement speed VR is equal to or greater than the threshold value TH2; and (3) Whether or not the rotational speed VS is equal to or greater than the threshold value TH3.

In the case that at least one of the above conditions (1) to (3) is satisfied, the start determination unit 75 determines that the predetermined start condition is satisfied. When it cannot be determined that the predetermined start condition is satisfied, the start determination unit 75 determines that the predetermined start condition is not satisfied.

When the predetermined start condition is satisfied, the start determination unit 75 determines to start the mist collector 34. When the predetermined start condition is not satisfied, the start determination unit 75 determines not to start the mist collector 34.

The collector control unit 76 controls the mist collector 34 based on a determination content of the start determination unit 75.

For example, when the start determination unit 75 determines that the mist collector 34 is to be started, the collector control unit 76 automatically starts the mist collector 34 and causes the mist collector 34 to collect the mist in the machining area 48.

On the other hand, when the start determination unit 75 determines that the mist collector 34 is not to be started, the collector control unit 76 does not automatically start the mist collector 34. If the start determination unit 75 determines that the mist collector 34 is not to be started and the mist collector 34 is operating, the collector control unit 76 causes the mist collector 34 to be stopped.

According to the collector control unit 76, the mist collector 34 is automatically started when a predetermined start condition is satisfied. As a result, the mist, powdery dust, etc. in the machining area 48 are collected by the mist collector 34.

The mist collector 34 is vibrated when operated. The vibration of the mist collector 34 may cause vibration of the workpiece. However, when the predetermined start condition is satisfied, there is a high possibility that the machining is performed in which the vibration of the mist collector 34 does not greatly affect the machine accuracy. Therefore, when the predetermined start condition is satisfied, the vibration of the mist collector 34 is unlikely to adversely affect the machine accuracy.

The machining in which the vibration of the mist collector 34 does not greatly affect the machine accuracy is, for example, the machining in which the vibration stronger than the vibration generated by the mist collector 34 is generated from the portion of the machining device 12 other than the mist collector 34. The machining may be, for example, rough machining. The rough machining tends to require a larger amount of cutting than the finishing. Accordingly, the rough machining tends to generate a large amount of mist, powdery dust, and the like in the machining area 48. That is, in the case that a large amount of mist, powdery dust, or the like is generated in the machining area 48, the control device 14 can automatically start the mist collector 34.

In the case that the predetermined start condition is not satisfied, there is a high possibility that the vibration of the mist collector 34 is causing the machining to have a large influence on the machine accuracy. In this regard, according to the collector control unit 76, in the case that the predetermined start condition is not satisfied, the mist collector 34 does not operate. This prevents the mist collector 34 from vibrating the workpiece in the case that a predetermined start condition is not satisfied. Therefore, the possibility of a significant deterioration in the machine accuracy is reduced. As described above, the vibration of the mist collector 34 greatly affects the machine accuracy in, for example, finishing, precision machining, and the like. In the finishing, the precision machining, and the like, there is a tendency that the mist, the powdery dust, and the like generated in the machining area 48 are small. That is, in the case that the amount of mist, powdery dust, or the like generated in the machining area 48 is small, the control device 14 can automatically stop the mist collector 34. In accordance with this feature, the power consumption of the mist collector 34 is suppressed.

It is preferable for the acquisition unit 73 to sequentially acquire at least one of the machining load LO, the relative movement speed VR, and the rotational speed VS while the machining control unit 74 performs machining. While the machining control unit 74 is performing machining, the start determination unit 75 preferably sequentially determines whether or not to start the mist collector 34 by using the latest information acquired by the acquisition unit 73. Thus, the collector control unit 76 can appropriately turn ON and OFF the mist collector 34 in accordance with a change in at least one of the machining load LO, the relative movement speed VR, and the rotational speed VS during machining.

While the machining control unit 74 is performing machining, the acquisition unit 73 preferably acquires all the information of the machining load LO, the relative movement speed VR, and the rotational speed VS. By using all the information of the machining load LO, the relative movement speed VR, and the rotational speed VS, the start determination unit 75 can accurately determine whether or not the predetermined start condition is satisfied.

The standby electrical power supply unit 68 is an electrical power supply that is separate from the main power supply of the control device 14. The standby electrical power supply unit 68 includes, for example, a battery. The standby electrical power supply unit 68 is integrated in the control device 14. However, the standby electrical power supply unit 68 may be provided in the machine tool 10 as an external power supply for the control device 14. Moreover, it should be noted that the main power supply for the control device 14 is not shown in the drawings.

In the case that the main power supply of the control device 14 is turned OFF while the mist collector 34 is in operation, the standby electrical power supply unit 68 supplies electrical power to each of the components of the control device 14. In accordance with this feature, even after the main power supply has been turned OFF, the collector control unit 76 can continue to control the mist collector 34.

For example, the main power supply of the control device 14 may be turned OFF before the collector control unit 76 causes the mist collector 34 to be stopped. In such a case, by supplying electrical power from the standby electrical power supply unit 68, the collector control unit 76 can cause the mist collector 34 to be automatically stopped even after the main power supply of the control device 14 is turned OFF. In accordance with this feature, the wasteful power consumption of the mist collector 34 is suppressed.

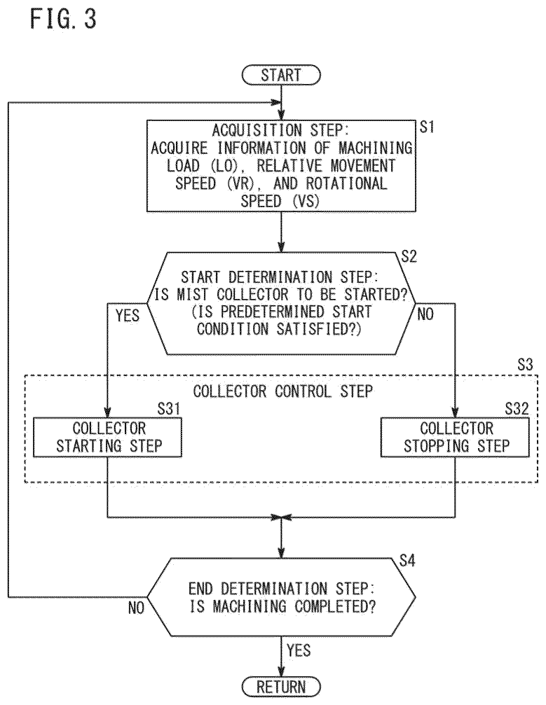

FIG. 3 is a flowchart illustrating the control method according to the embodiment.

The control device 14 can execute a control method, for example, as illustrated in FIG. 3. The control device 14 executes the control method of FIG. 3 while the machining control unit 74 performs machining based on the machining program 72. Moreover, at the starting time of the control method, the mist collector 34 is stopped. The control method of FIG. 3 includes an acquisition step S1, a start determination step S2, a collector control step S3, and an end determination step S4. The collector control step S3 includes a collector starting step S31 and a collector stopping step S32.

In the acquisition step S1, the acquisition unit 73 acquires at least one type of information from among the machining load LO, the relative movement speed VR, and the rotational speed VS. It is preferable for the acquisition unit 73 to acquire all the information of the machining load LO, the relative movement speed VR, and the rotational speed VS.

In the start determination step S2, the start determination unit 75 determines whether or not to start the mist collector 34. In order to determine whether or not to start the mist collector 34, the start determination unit 75 determines whether or not a predetermined start condition is satisfied based on the information (LO, VR, VS) acquired by the acquisition unit 73 in the acquisition step S1.

When the predetermined start condition is satisfied (S2: YES), the start determination unit 75 determines to start the mist collector 34. When the predetermined start condition is not satisfied (S2: NO), the start determination unit 75 determines not to start the mist collector 34. The collector starting step S31 or the collector stopping step S32 is started in accordance with the determination content in the start determination step S2.

In the case that it is determined in the start determination step S2 that the mist collector 34 is to be started, the collector starting step S31 is started. In the collector starting step S31, the collector control unit 76 controls the mist collector 34 to automatically start the mist collector 34. If the mist collector 34 is already operating, the collector control unit 76 maintains the operating state of the mist collector 34.

When it is determined in the start determination step S2 that the mist collector 34 is not started, the collector stopping step S32 is started. In the collector stopping step S32, the collector control unit 76 controls the mist collector 34 to cause the mist collector 34 to be automatically stopped. In the case that the mist collector 34 has already been stopped, the collector control unit 76 maintains the stopped state of the mist collector 34.

In the end determination step S4, the machining control unit 74 determines whether or not the machining based on the machining program 72 is completed. If the machining is not finished (S4: NO), the flow from the acquisition step S1 to the end determination step S4 is repeated. When the machining is finished (S4: YES), the control method of FIG. 3 is brought to an end. In the case that the machining is finished and the mist collector 34 is operating, the collector control unit 76 causes the mist collector 34 to be automatically stopped.

### Exemplary Modifications

Hereinafter, a description will be given concerning exemplary modifications of the above-described embodiment. However, any descriptions that are duplicative or overlap with those of the above-described embodiment will be appropriately omitted in the following description. Unless otherwise specified, the same reference numerals as in the above-described embodiment are used in referring to the elements that have already been described in the embodiment.

### Exemplary Modification 1

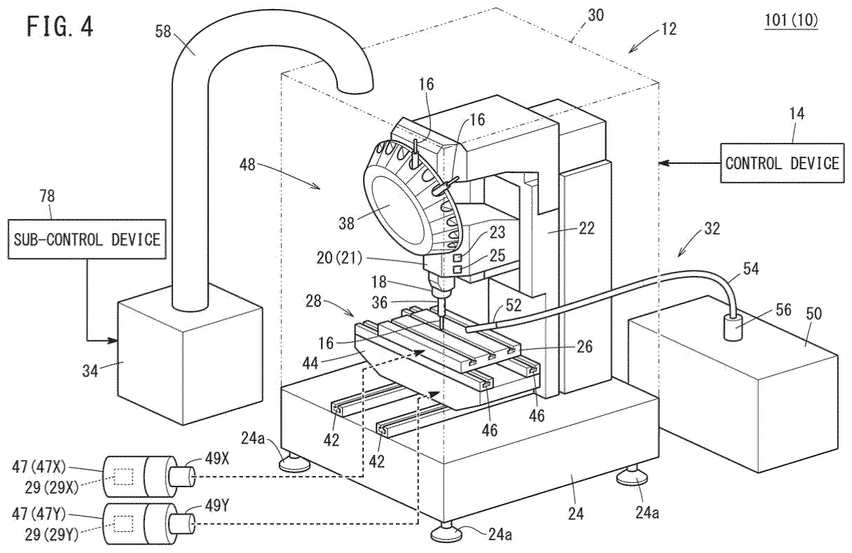

FIG. 4 is a schematic diagram of a machine tool 101 (10) according to a first exemplary modification.

The machine tool 101 is further equipped with a sub-control device 78. In the machine tool 101, the standby electrical power supply unit 68 of the control device 14 may be omitted.

The sub-control device 78 is a computer that is separate from the control device 14. The sub-control device 78, for example, is equipped with a processor and a memory. The sub-control device 78 may also be equipped with an integrated circuit, a discrete device, or the like.

In the case that the control device 14 is stopped, the sub-control device 78 controls the mist collector 34 instead of the collector control unit 76. Therefore, even if the control device 14 is stopped, the mist collector 34 is controlled by the sub-control device 78 in the same manner as in the embodiment.

For example, if the main power supply of the control device 14 is turned OFF before the collector control unit 76 causes the mist collector 34 to be stopped, the sub-control device 78 can cause the mist collector 34 to be stopped, instead of the control device 14.

Moreover, it is preferable for the sub-control device 78 and the control device 14 to communicate with each other as appropriate, and to share the data necessary for controlling the mist collector 34. For example, the sub-control device 78 and the control device 14 share the information acquired by the acquisition unit 73, the determination content by the start determination unit 75, or the progress of the machining. In accordance with these features, the sub-control device 78 is capable of smoothly taking over the control that was being performed by the collector control unit 76. According to the present exemplary modification, even after the control device 14 is stopped, the control of the mist collector 34 can be continued by the sub-control device 78.

### Exemplary Modification 2

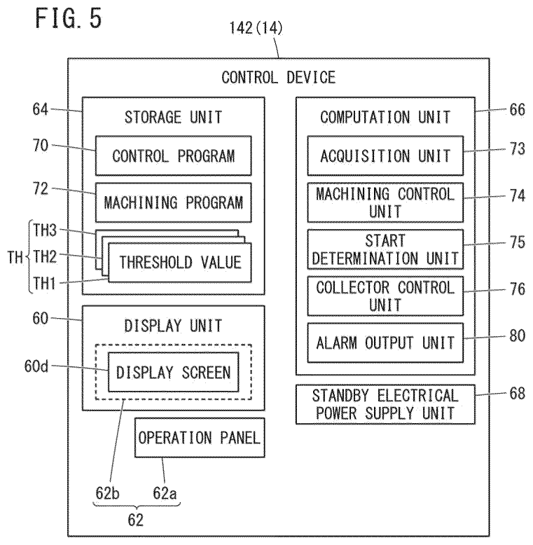

FIG. 5 is a block diagram of a control device 142 (14) according to an exemplary modification 2.

The control device 142 is further equipped with an alarm output unit 80.

The alarm output unit 80 outputs an alarm in the case that an abnormality has occurred in the machine tool 10. For example, the machine tool 10 is appropriately provided with non-illustrated sensors for the purpose of detecting malfunctions or troubles in each of the respective components such as the spindle 18, the spindle head 20, the table drive unit 28, etc. The alarm output unit 80 determines whether or not a malfunction has occurred in the machine tool 10 based on the signals output by the sensors. In the case that a malfunction is detected in any of the respective components of the machine tool 10, the alarm output unit 80 issues a notification to the operator, for example via the display unit 60, to the effect that a malfunction has occurred.

In the case that the alarm output unit 80 has output an alarm prior to the start of the machining, the machining control unit 74 does not start the machining until the cause of the alarm is eliminated. Further, in the case that the alarm output unit 80 has output an alarm after the start of the machining, the machining control unit 74 suspends the machining based on the machining program 72 until the cause of the alarm is eliminated.

In the case that the alarm output unit 80 outputs an alarm, the collector control unit 76 prohibits the operation of the mist collector 34 until the cause of the alarm is eliminated, regardless of the determination content of the start determination unit 75. In the case that the mist collector 34 is operating at the time when the alarm is output, the collector control unit 76 causes the mist collector 34 to be stopped regardless of the determination content of the start determination unit 75.

According to the present exemplary modification, in the case that an abnormality has occurred in the machine tool 10, the mist collector 34 is prevented from operating.

### Exemplary Modification 3

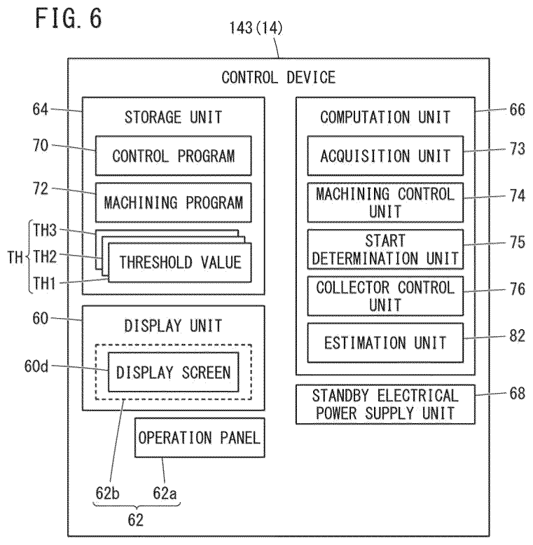

FIG. 6 is a block diagram of a control device 143 (14) according to an exemplary modification 3.

The control device 143 further includes an estimation unit 82.

The estimation unit 82 estimates (calculates) at least one of the estimated values of the machining load LO, the relative movement speed VR, and the rotational speed VS based on the machining program 72.

For example, the machining program 72 includes a control command to drive the spindle motor 21 at a predetermined torque. The estimation unit 82 estimates the machining load LO based on the control command. Further, for example, a control command to rotate the shaft 49X at a predetermined speed is included in the machining program 72. The estimation unit 82 estimates the relative movement speed VRX based on the control command. Further, for example, a control command to rotate the shaft of the spindle motor 21 at a predetermined speed is included in the machining program 72. The estimation unit 82 estimates the rotational speed VS based on the control command.

The estimation unit 82 estimates at least one of the estimated values of the machining load LO, the relative movement speed VR, and the rotational speed VS by using a mathematical equation. The mathematical equation is predetermined based on experiments. The estimation unit 82 may use different mathematical equations for the estimation of the machining load LO, the estimation of the relative movement speed VR, and the estimation of the rotational speed VS.

The estimation unit 82 may refer to information other than the machining program 72 as appropriate in order to estimate at least one of the machining load LO, the relative movement speed VR, and the rotational speed VS. For example, the machining load LO varies depending on the material of a workpiece or the tool 16. Therefore, the estimation unit 82 may refer to the material of the workpiece or the tool 16 in order to calculate the estimated value of the machining load LO. In this case, the storage unit 64 may store the material of the workpiece or the tool 16.

The acquisition unit 73 may acquire the value estimated by the estimation unit 82 as information.

According to the present modification, the start determination unit 75 can determine whether or not to start the mist collector 34 before the machining is started. That is, the estimation unit 82 can estimate (calculate) at least one of the estimated values of the machining load LO, the relative movement speed VR, and the rotational speed VS based on the machining program 72, before machining is started. The acquisition unit 73 can acquire the estimated value before the machining is started. Thus, the start determination unit 75 can determine whether to start the mist collector 34 based on the comparison between the estimated value and the threshold value TH, before the machining is started.

### Combination of Plural Exemplary Modifications

The above-described plurality of exemplary modifications may be combined as appropriate within a range in which there are no contradictions therebetween.

### Modified Embodiments

It should be noted that the present invention is not limited to the embodiment described above, and various alternative or additional configurations may be adopted therein without departing from the essence and gist of the present invention.

For example, according to the above embodiment, the mist collector 34 stops when the machining control unit 74 completes the machining. However, the collector control unit 76 may control the mist collector 34 to cause the mist collector 34 to collect the mist in the machining area 48 until a predetermined time period has elapsed from the completion of the machining. By intentionally operating the mist collector 34 after the completion of the machining, it is possible to prevent a loss in the collection of the mist. The predetermined time period is specified in advance to the collector control unit 76 by, for example, an operator through the operation unit 62. However, the predetermined time period may be specified by the manufacturer of the machine tool 10.

In addition, for example, according to the above embodiment, the acquisition unit 73 acquires the machining load LO based on the torque of the spindle motor 21. However, the machining load LO may be calculated based on the drive current of the spindle motor 21. Therefore, the machine tool 10 may further include, for example, a current sensor for detecting the drive current of the spindle motor 21. Thus, the acquisition unit 73 can acquire the information of the machining load LO based on the detection signal output from the current sensor.

Further, for example, according to the above embodiment, the relative movement speed VR is the relative movement speed VRX in the X direction or the relative movement speed VRY in the Y direction. However, the relative movement speed VR may be a composite speed of the relative movement speed VRX and the relative movement speed VRY.

Further, for example, the coolant discharge method is not limited to being that of the embodiment. For example, the coolant may be discharged using a center-through method. In that case, the coolant supply device 32 supplies the coolant to the spindle 18. Further, the coolant may flow along the inner wall of the cover 30 (the machining area 48).

For example, the machining device 12 may further be equipped with a non-illustrated recovery member in order to recover the coolant that falls downwardly of the table 26. Such a recovery member, for example, is an oil pan provided on the pedestal 24. A portion of the coolant supplied to the machining area 48 falls downwardly of the table 26 without turning into a mist. According to the present exemplary modification, it is possible to collect the coolant that has fallen downwardly of the table 26. The recovered coolant may be returned to the coolant tank 50. In accordance with this feature, the coolant supply device 32 is capable of reusing the coolant that has been collected. In this instance, it is preferable for a filtering device (a filter) to be disposed between the recovery member and the coolant tank 50. In accordance with this feature, a clean coolant can be returned to the coolant tank 50.

At least one of the X-axis motor 47X and the Y-axis motor 47Y may be a linear motor. In the case where the X-axis motor 47X is a linear motor, the encoder 29X is a linear encoder. In the case where the Y-axis motor 47Y is a linear motor, the encoder 29Y is a linear encoder.

### Invention That Can Be Understood from the Embodiments

The invention that can be grasped from the above embodiment and modifications are described below.

### First Aspect of Invention

The first aspect of invention is the control device (14) for the machine tool (10) including the table (26) supporting the workpiece to be machined by the tool (16) in the machining area (48), the spindle (18) to which the tool is mounted and which rotates and moves relative to the table, and the mist collector (34) configured to collect mist in the machining area, the control device including the acquisition unit (73) configured to acquire at least one type of information from among the machining load (LO) applied to the tool by performing machining on the workpiece, the relative movement speed (VR) of the spindle with respect to the table, and the rotational speed (VS) of the spindle, the start determination unit (75) configured to determine whether or not to start the mist collector based on the at least one type of information acquired by the acquisition unit, and the collector control unit (76) configured to automatically control the mist collector based on the determination content of the start determination unit.

In accordance with such features, since the mist collector is automatically controlled depending on the content of machining, vibration of the mist collector is prevented from having a large adverse effect on the machine accuracy.

In the control device, the acquisition unit may acquire the information of the machining load based on the drive current or the torque of the spindle motor (21) of the spindle. In accordance with this feature, the mist collector can be turned ON/OFF automatically based on the machining load acquired during machining.

In the control device, the acquisition unit may acquire the information of the rotational speed based on the detection signal of the encoder (25) provided in the spindle motor (21) of the spindle. In accordance with this feature, the mist collector can be automatically turned ON and OFF in accordance with the rotational speed acquired during machining.

In the control device, the acquisition unit may acquire the information of the relative movement speed based on the detection signal of the encoder (29) provided in the feed axis motor (47) configured to relatively move the spindle and the table. In accordance with this feature, the mist collector can be automatically turned ON and OFF based on the relative movement speed obtained during machining.

The control device may further includes the estimation unit (82) configured to estimate the value, as the estimated value, of at least one of the machining load, the relative movement speed, and the rotational speed, based on the machining program (72) for performing the machining, wherein the acquisition unit acquires the estimated value as the information. Thus, it is possible to determine whether or not the mist collector is automatically started before the machining is started.

In the control device, the start determination unit may determine whether or not the predetermined start condition is satisfied, and determine not to start the mist collector in the case that the predetermined start condition is not satisfied, and the predetermined start condition may be satisfied in the case that at least one of the machining load, the relative movement speed, and the rotational speed acquired by the acquisition unit is equal to or greater than the threshold value (TH). In accordance with such features, deterioration of the machine accuracy due to vibration of the mist collector is prevented.

In the control device, the threshold value may include the plurality of threshold values, and the start determination unit may use the threshold values different from each other in accordance with the machining load, the relative movement speed, and the rotational speed. In accordance with this feature, deterioration of the machine accuracy due to vibration of the mist collector is prevented.

In the control device, the start determination unit may determine to start the mist collector in the case that the predetermined start condition is satisfied. In accordance with this feature, the mist collector is automatically started, the mist is prevented from leaking out to the exterior of the machining area. Thus, in the case that there is little possibility that the machine accuracy is deteriorated due to the vibration of the mist collector, the mist can be collected by the mist collector.

The control device may further include the alarm output unit (80) configured to output the alarm in the case that an abnormality has occurred in the machine tool, and in the case that the alarm output unit has output the alarm, the collector control unit may prohibit the operation of the mist collector, regardless of the determination content of the start determination unit. In accordance with this feature, the mist collector is prevented from operating in the case that an abnormality has occurred in the machine tool.

### Second Aspect of Invention

A second aspect of invention is a machine tool including the control device according to the first aspect of invention.

In accordance with this feature, since the mist collector is automatically controlled in accordance with the content of the machining, the vibration of the mist collector is prevented from having a large adverse effect on the machine accuracy.

The machine tool may further include the sub-control device (78) configured to control the mist collector instead of the collector control unit in the case that the control device is stopped. In accordance with this feature, even in the case that the control device is stopped, an automated control of the mist collector is carried out.

### Third Aspect of Invention

A third aspect of invention is the control method for the machine tool (10) including the table (26) supporting the workpiece to be machined by the tool (16) in the machining area (48), the spindle (18) to which the tool is mounted and which rotates and moves relative to the table, and the mist collector (34) configured to collect mist in the machining area, the control method including the acquisition step (S1) in which the computer (14) acquires at least one type of information from among the machining load (LO) applied to the tool by performing machining on the workpiece, the relative movement speed (VR) of the spindle with respect to the table, and the rotational speed (VS) of the spindle, the start determination step (S2) in which the computer determines whether or not to start the mist collector based on the at least one type of information acquired in the acquisition step, and the collector control step (S3) in which the computer controls the mist collector based on the determination content in the start determination step.

In accordance with such features, since the mist collector is automatically controlled in accordance with the content of the machining, the vibration of the mist collector is prevented from having a large adverse effect on the machine accuracy.

### REFERENCE SIGNS LIST

10, 101: machine tool
12: machining device
14, 142, 143: control device
16: tool
18. spindle
21: spindle motor
25, 29: encoder
26: table
34: mist collector
47: feed axis motor
48: machining area
72: machining program
73: acquisition unit
75; start determination unit
76: collector control unit
78: sub-control device
80: alarm output unit
82: estimation unit
LO: machining load
TH: threshold value
VR: relative movement speed
VS: rotational speed

1. A control device for a machine tool comprising a table supporting a workpiece to be machined by a tool in a machining area, a spindle to which the tool is mounted and which rotates and moves relative to the table, and a mist collector configured to collect mist in the machining area, the control device comprising:
an acquisition unit configured to acquire at least one type of information from among a machining load applied to the tool by performing machining on the workpiece, a relative movement speed of the spindle with respect to the table, and a rotational speed of the spindle;
a start determination unit configured to determine whether or not to start the mist collector based on the at least one type of information acquired by the acquisition unit; and
a collector control unit configured to automatically control the mist collector based on a determination content of the start determination unit.

2. The control device according to claim 1, wherein the acquisition unit acquires the information of the machining load based on a drive current or a torque of a spindle motor of the spindle.

3. The control device according to claim 1, wherein the acquisition unit acquires the information of the rotational speed based on a detection signal of an encoder provided in a spindle motor of the spindle.

4. The control device according to claim 1, wherein the acquisition unit acquires the information of the relative movement speed based on a detection signal of an encoder provided in a feed axis motor configured to relatively move the spindle and the table.

5. The control device according to claim 1, further comprising an estimation unit configured to estimate a value, as an estimated value, of at least one of the machining load, the relative movement speed, and the rotational speed, based on a machining program for performing the machining, wherein the acquisition unit acquires the estimated value as the information.

6. The control device according to claim 1, wherein the start determination unit determines whether or not a predetermined start condition is satisfied, and determines not to start the mist collector in a case that the predetermined start condition is not satisfied, and the predetermined start condition is satisfied in a case that at least one of the machining load, the relative movement speed, and the rotational speed acquired by the acquisition unit is equal to or greater than a threshold value.

7. The control device according to claim 6, wherein the threshold value includes a plurality of the threshold values, and the start determination unit uses the threshold values different from each other in accordance with the machining load, the relative movement speed, and the rotational speed.

8. The control device according to claim 6, wherein the start determination unit determines to start the mist collector in a case that the predetermined start condition is satisfied.

9. The control device according to claim 1, further comprising an alarm output unit configured to output an alarm in a case that an abnormality has occurred in the machine tool, wherein, in a case that the alarm output unit has output the alarm, the collector control unit prohibits an operation of the mist collector, regardless of the determination content of the start determination unit.

10. A machine tool comprising the control device according to claim 1.

11. The machine tool according to claim 10, further comprising a sub-control device configured to control the mist collector instead of the collector control unit in a case that the control device is stopped.

12. A control method for a machine tool comprising a table supporting a workpiece to be machined by a tool in a machining area, a spindle to which the tool is mounted and which rotates and moves relative to the table, and a mist collector configured to collect mist in the machining area, the control method comprising:
an acquisition step in which a computer acquires at least one type of information from among a machining load applied to the tool by performing machining on the workpiece, a relative movement speed of the spindle with respect to the table, and a rotational speed of the spindle;
a start determination step in which the computer determines whether or not to start the mist collector based on the at least one type of information acquired in the acquisition step; and
a collector control step in which the computer controls the mist collector based on a determination content in the start determination step.
